(19) United States
(12) Patent Application Publication
(10) Pub. No.: US 2013/0241891 A1
(43) Pub. Date: Sep. 19, 2013

(54) PHOTOSENSOR BUILTIN DISPLAY APPARATUS

(71) Applicant: Naru Usukura, Osaka-shi (JP)

(72) Inventor: Naru Usukura, Osaka-shi (JP)

(73) Assignee: SHARP KABUSHIKI KAISHA, Osaka-shi, Osaka (JP)

(21) Appl. No.: 13/883,288

(22) PCT Filed: Oct. 28, 2011
(86) PCT No.: PCT/JP2011/074984

§ 371 Date: May 17, 2013

(30) Foreign Application Priority Data
Nov. 4, 2010 (JP) 2010-247109

(51) Int. Cl. G06F 3/042

(52) U.S. Cl. CPC G06F 3/0425
USPC 345/175

(57) ABSTRACT

Provided is a photosensor builtin display apparatus that controls blurring of a sensor image and a drop in resolution of the sensor image. The photosensor builtin display apparatus includes an active matrix substrate having a plurality of pixel electrodes, a counter substrate having a counter electrode opposed to the plurality pixel electrodes, a display medium layer interposed between the active matrix substrate and the counter substrate, and a photosensor arranged within a pixel region of the active matrix substrate. When the photosensor (in an area a(i+1, j+1), for example) performs an image capturing operation, the display medium layer right above the photosensor is configured to be in a light-blocking state, and the display medium diagonally above the photosensor (in an area a(i,j)) is configured to be in a light-transmissive state.

### TECHNICAL FIELD

The present invention relates to a photosensor builtin display apparatus that can capture an image on an original document or the like.

### BACKGROUND ART

A photosensor builtin display apparatus including a photosensor, such as a photodiode, in a pixel thereof is disclosed. Such a photosensor builtin display apparatus can detect an ambient light level and capture an image of an object close to a display. Recently in particular, a demand for a function to capture an image from an original document placed in front of a display of a photosensor builtin display apparatus, i.e., the demand for a so-called scanner function, has been mounting.

Japanese Unexamined Patent Application Publication No. 2004-153329 discloses a conventional photosensor builtin display apparatus that captures such image. The disclosed photosensor builtin display apparatus captures a color image. The display apparatus disclosed in Japanese Unexamined Patent Application Publication No. 2004-153329 captures information of each of R, G, and B colors by successively lighting display pixels of R, G, and B.

Since an optical distance on the order of several hundred μm is typically present between the photosensor and an image capture target (such as a surface of an original document) in the conventional photosensor builtin display apparatus, not only a light ray reflected from the image capture target but also a reflected light ray entering in a diagonal direction are incident on the photosensor. In such a case, the reflected light ray entering in the diagonal direction becomes a noise component, causing blurring of a sensor image and a decreases in the resolution of the sensor image.

### SUMMARY OF INVENTION

It is an object of the present invention to provide the photosensor builtin display apparatus that controls the blurring of the sensor image and the decrease in the resolution of the sensor image.

To achieve the above object, the photosensor builtin display apparatus disclosed herein includes an active matrix substrate having a plurality of pixel electrodes, a counter substrate having a counter electrode opposed to the plurality pixel electrodes, a display medium layer interposed between the active matrix substrate and the counter substrate, and a photosensor arranged within a pixel region of the active matrix substrate. When the photosensor performs an image capturing operation, the display medium layer right above the photosensor is configured to be in a light-blocking state, and the display medium layer diagonally above the photosensor is configured to be in a light-transmissive state.

The arrangement disclosed herein provides a photosensor builtin display apparatus that controls the blurring of the sensor image and the decrease in the resolution of the sensor image.

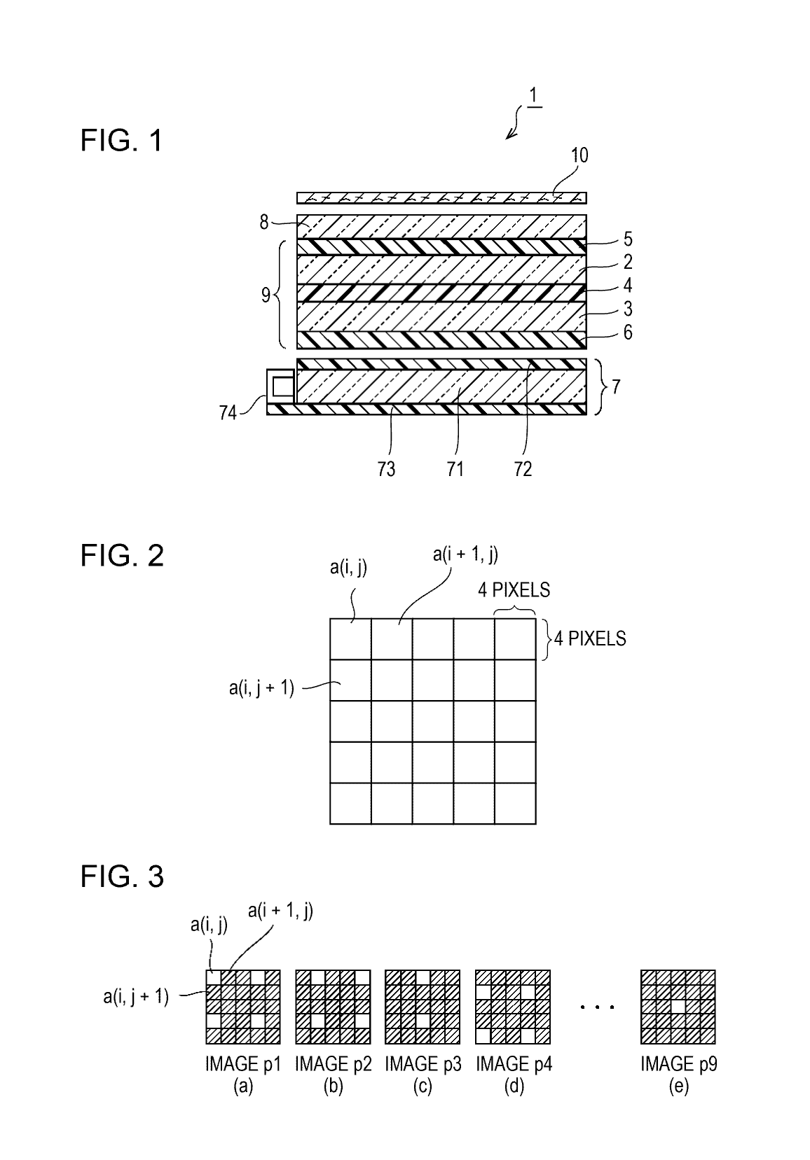

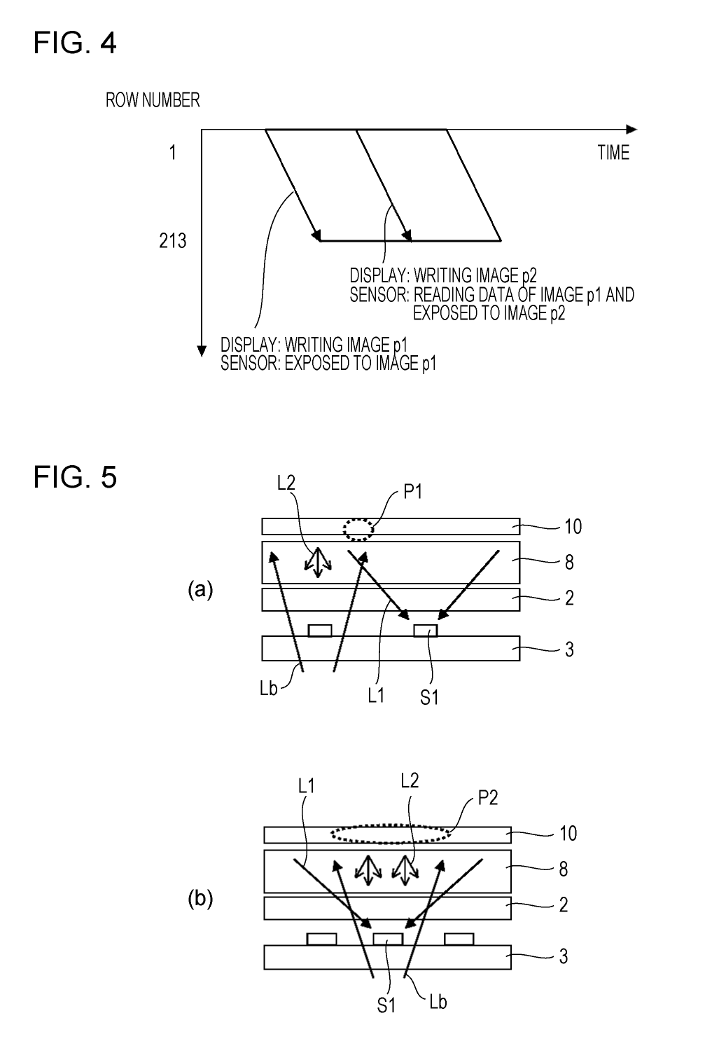

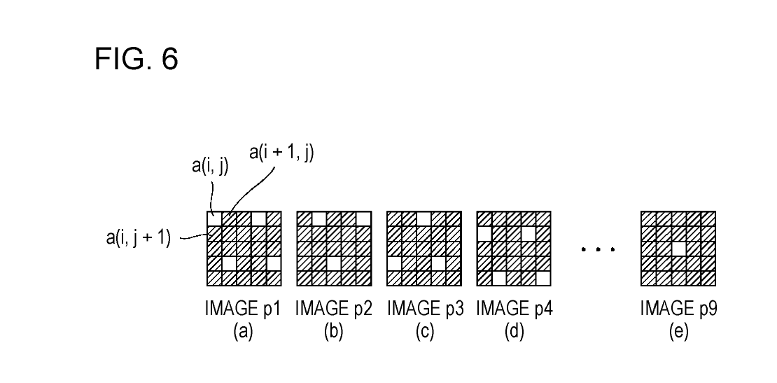

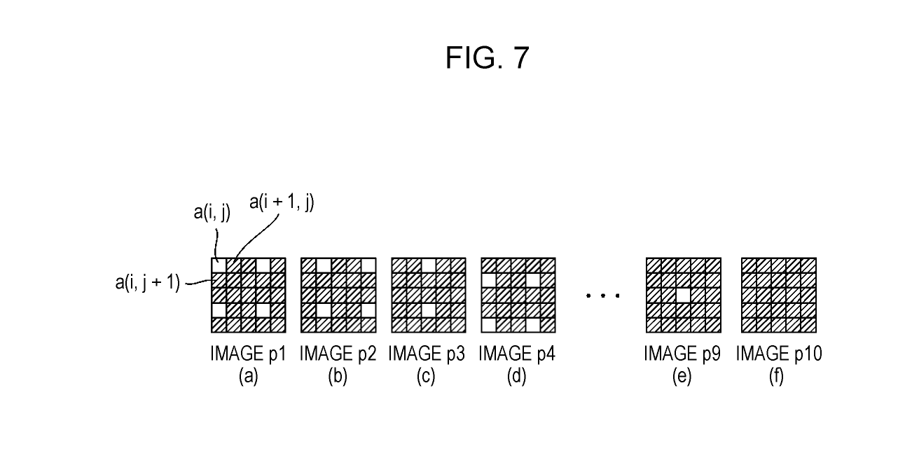

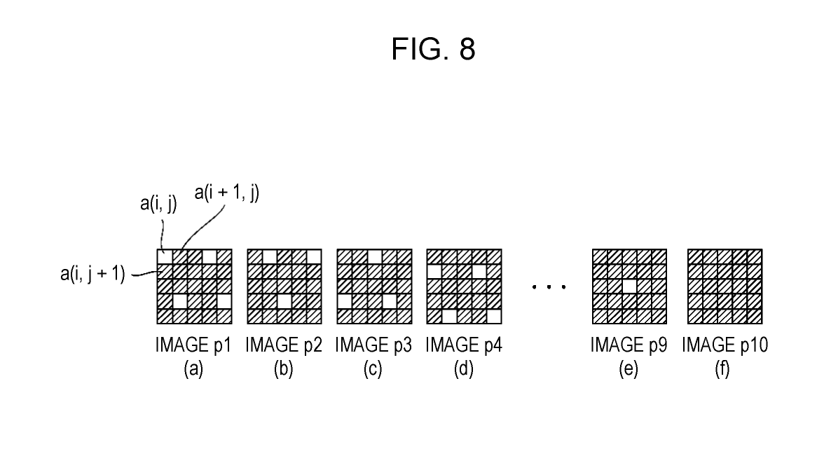

### BRIEF DESCRIPTION OF DRAWINGS

[FIG. 1] FIG. 1 is a sectional view diagrammatically illustrating a photosensor builtin liquid-crystal display apparatus of an embodiment of the present invention.

[FIG. 2] FIG. 2 diagrammatically illustrates a layout relationship between a pixel circuit and a photosensor in the photosensor builtin liquid-crystal display apparatus of a first embodiment.

[FIG. 3] FIG. 3 illustrates an image pattern displayed by display pixels while the photosensor performs an image capturing operation in the photosensor builtin liquid-crystal display apparatus of the first embodiment.

[FIG. 4] FIG. 4 is a timing diagram illustrating a display on a display pixel and the image capturing operation of the photosensor.

[FIG. 5] FIG. 5(a) is a sectional view illustrating a light ray incident on the photosensor that performs the image capturing operation in the photosensor builtin liquid-crystal display apparatus of the first embodiment, and FIG. 5(b) is a sectional view illustrating a light ray incident on the photosensor that performs the image capturing operation in a liquid-crystal display apparatus as a comparative example.

[FIG. 6] FIG. 6 illustrates another example of the image pattern displayed by the display pixels while the photosensor performs the image capturing operation in the photosensor builtin liquid-crystal display apparatus of the first embodiment.

[FIG. 7] FIG. 7 illustrates an example of an image pattern displayed by display pixels while a photosensor performs the image capturing operation in the photosensor builtin liquid-crystal display apparatus of a second embodiment.

[FIG. 8] FIG. 8 illustrates another example of the image pattern displayed by the display pixels while the photosensor performs the image capturing operation in the photosensor builtin liquid-crystal display apparatus of the second embodiment.

### DESCRIPTION OF EMBODIMENTS

A touchsensor builtin display apparatus of an embodiment of the present invention includes an active matrix substrate having a plurality of pixel electrodes, a counter substrate having a counter electrode opposed to the plurality pixel electrodes, a display medium layer interposed between the active matrix substrate and the counter substrate, and a photosensor arranged within a pixel region of the active matrix substrate, wherein when the photosensor performs an image capturing operation, the display medium layer right above the photosensor is configured to be in a light-blocking state, and the display medium layer diagonally above the photosensor is configured to be in a light-transmissive state (a first arrangement).

With this arrangement, image capturing of the photosensor is performed on only a light ray entering the photosensor from diagonally above, and an effective area of light capturing is small. As result, a photosensor builtin display apparatus that can acquire a crisp sensor image with less blur is thus provided.

In the first arrangement, the photosensor builtin display apparatus preferably further includes an image corrector unit that subtracts data acquired via the photosensor with an entire portion of the display medium layer in the light-blocking state from data acquired by the photosensor in the image capturing operation (a second arrangement).

If stray light is still present even with the display medium layer in the light-blocking state, the second arrangement can offset noise caused by the stray light. As a result, a more crisp sensor image with the noise component removed is obtained.

In the first and second arrangements, the photosensor may be a light detecting element that receives visible light (a third arrangement). In the third arrangement, the photosensor builtin display apparatus may preferably includes a back-light unit, wherein a light ray emitted from a light source of the back-light unit includes a visible light component (a fourth arrangement). In the third and fourth arrangements, the photosensor builtin display apparatus may further include a color filter arranged above the photosensor (a fifth arrangement). With this arrangement, a color image can be captured as a sensor image.

In the first through fifth arrangements, the image capturing operation is preferably performed within a blanking period (a sixth arrangement). With the sixth arrangement, image displaying is not affected by the image capturing operation.

In the first through sixth arrangements, the display medium layer is preferably a liquid-crystal layer.

Specific embodiments of the present invention are described with reference to the drawings.

### First Embodiment

FIG. 1 is a sectional view diagrammatically illustrating a photosensor builtin liquid-crystal display apparatus 1 of an embodiment of the present invention. As illustrated in FIG. 1, the photosensor builtin liquid-crystal display apparatus 1 includes a liquid-crystal layer 4 between a counter substrate (also referred to as a color filter substrate) 2 and an active matrix substrate 3. A back-light unit 7 is arranged behind the active matrix substrate 3. Optical films 5 and 6 are respectively glued onto a surface of the counter substrate 2 opposed to the side of the liquid-crystal layer 4 and a surface of the active matrix substrate 3 opposed to the side of the liquid-crystal layer 4. In other words, in the arrangement of FIG. 1, the counter substrate 2, the active matrix substrate 3, the liquid-crystal layer 4, and the optical films 5 and 6 are main elements of a liquid-crystal panel 9. It is noted that FIG. 1 only diagrammatically illustrates the photosensor builtin liquid-crystal display apparatus 1, and in the embodiment of the present invention, any element not illustrated in FIG. 1 may be added.

Although the liquid-crystal panel 9 is not limited to any particular mode, a vertical alignment (VA) mode is used in the embodiment herein.

Films appropriately adjusted for the liquid-crystal mode of the liquid-crystal panel 9 are used for the optical films 5 and 6. A polarizer, a phase plate, a viewing angle compensator, and the like may be used for the optical film 5 on the counter substrate 2 as necessary. A polarizer, a phase plate, a viewing angle compensator, a reflective-type polarizer film, and the like may be used for the optical film 6 on the active matrix substrate 3 as necessary. The reflective-type polarizer film has an effect of improving a usage rate of light output from the back-light unit 7 by preventing the polarizer on the optical film 6 from absorbing the light output from the back-light unit 7.

The back-light unit 7 includes a light guide 71, an optical film 72, a reflector 73, LED 74, etc. The back-light unit 7 of FIG. 1 is a so-called edge type back-light unit in which the LED 74 is arranged as a light source on a side surface of the light guide 71. A prism and a lens pattern are formed on each of the top and bottom surface of the light guide 71. In this way, a light ray emitted from the LED 74 travels within of the light guide 71 while being emitted toward the liquid-crystal panel 9.

Although the LED 74 is illustrated as a light source in the arrangement of FIG. 1, a cold-cathode tube may be used in place of the LED. The light source may be arranged not only one side surface but also on two side surfaces. Also, a direct back-light unit may be used for the back-light unit 7.

The reflector 73 is laminated on a surface of the light guide 71 opposed to the side of the liquid-crystal panel 9. A silver sheet, a polyester-based resin reflector film, or a white polyethylene terephthalate (PET) film, or the like may serve as the reflector 73.

The optical member 72 is arranged on a surface of the light guide 71 facing the side of the liquid-crystal panel 9. A difusser, a brightness enhancement film, and the like may be arranged for the optical member 72 as necessary. For example, a laminate of two brightness enhancement films and two diffusers may be used for the optical film 72.

The photosensor builtin liquid-crystal display apparatus 1 includes a plurality of pixel circuits and a plurality photosensors, two-dimensionally arranged in a pixel array on the active matrix substrate 3. Each of the pixel circuits includes a pixel electrode and a thin-film transistor (TFT). The photosensor may be a photodiode, for example. In a semiconductor process to form the TFT of the pixel circuit, the photodiode can be manufactured at the same time when the TFT is manufactured.

When a desired signal voltage is applied to the pixel electrode via the TFT on the active matrix substrate 3, liquid-crystal molecules are oriented in response to the signal voltage between the counter electrode on the counter substrate 2 and the pixel electrode. The pixel is then set to be in a display state of desired gradation of tone.

A protective plate 8 is preferably arranged on a top surface of the liquid-crystal panel 9 for protection. In the present embodiment, the protective plate 8 has a thickness of 0.2 mm and is glued onto the top surface of the protective plate 8 using an adhesive.

An original document 10 is placed above the surface of the liquid-crystal panel 9 opposed to the side of the back-light unit 7 and the back-light unit 7 is lighted. A light ray output from the back-light unit 7 is reflected from the original document, and the reflected light ray reaches the photosensor of the active matrix substrate 3. If a surface of the original document 10 is black, an amount of reflected light is small, and if the surface of the original document 10 is white, an amount of reflected light is large. By obtaining a gradation signal in response to an amount of received light of the photosensor, the photosensor builtin liquid-crystal display apparatus 1 functions as a scanner.

In the present embodiment, a monochrome scanner is constructed using a while light-emitting diode as the LED 74. In the photosensor builtin liquid-crystal display apparatus 1, however, a color scanner may be constructed using the R, G, and B color diodes as the LED 74 or by arranging a color filter on the diodes. Optionally, an infrared LED may be used as the LED 74.

An image capturing operation of the photosensor builtin liquid-crystal display apparatus 1 of the present embodiment is described with reference to the drawings. In the following discussion, the photosensor builtin liquid-crystal display apparatus 1 is 4″ FWVGA (480 pixel circuits horizontally×854 pixel circuits vertically) and one photosensor is arranged on every 16 pixel circuits (4 pixel circuits vertically×4 pixel circuits horizontally). Resolution of the image acquired by the photosensors of the present embodiment is 120 pixels horizontally×213 pixels vertically. This is only an example, and the number of pixel circuits and the number of photosensors are optionally set.

In the photosensor builtin liquid-crystal display apparatus 1 of the present embodiment, 120 photosensors horizontally and 213 photosensors vertically are divided into photosensor groups, each group including nine photosensors of three photosensors horizontally (in a column direction)×three photosensors vertically (in a row direction). In an image capturing operation, only one of the nine photosensors in each group captures an image. A pixel right on top of a photosensor that captures an image is set to be in dark (light-blocking state), and a pixel spaced away from that photosensor is set to be in white (light-transmissive state).

A region a having a square shape denotes a region having a photosensor arranged therewithin. More specifically, each region a in FIG. 2 includes 16 pixel circuits inclusive of 4 pixel circuits vertically×4 pixel circuits horizontally. In the following discussion, a region a at the leftmost column at the first row is labeled (i,j) to individually identify the regions a in FIG. 2. Regions present to the right of the region (i,j) at the same row as the region a(i,j) are labeled a(i+1,j), a(i+2,j), a(i+3,j), and a(i+4,j). Regions present below the region a(i,j) on the same column as the region a(i,j) are labeled a(i,j+1), a(i,j+2), a(i,j+3), and a(i,j+4).

When the photosensor in a region a(k,m) captures an image in the photosensor builtin liquid-crystal display apparatus 1, only a pixel in a region a(k−1,m−1) out of eight regions a surrounding the region a(k,m) is in a white display, and the pixels in the remaining seven regions a are in a dark display. The image capturing operation continues with the region a set to be in a white display shifted until all the nine photosensors in the group have completed image capturing.

Referring to FIGS. 3 and 4, the image capturing operation of the photosensor is specifically described. In an example of FIG. 3, a group is formed of photosensors in nine regions of a(i+1,j+1), a(i+2,j+1), a(i+3,j+1), a(i+1,j+2), a(i+2,j+2), a(i+3,j+2), a(i+1,j+3), a(i+2,j+3), and a(i+3,j+3). The photosensors in nine regions successively perform the image capturing operation.

In the example of FIG. 3, the photosensor in the region a(i+1,j+1) captures an image in response to a light ray reflected from the original document 10. In the meantime, an image p1 is displayed on the liquid-crystal panel 9 as illustrated in FIG. 3(a). More specifically, all the display pixels in the region a(i,j) are displayed in white. While the photosensor at the region a(i+1,j+1) captures an image, only the region (i,j) diagonally left above the region a(i+1,j+1) out of eight regions surrounding the region a(i+1,j+1) is displayed in white, and the remaining seven regions, i.e., a(i+1,j), a(i+2,j), a(i,j+1), a(i+2,j+1), a(i,j+2), a(i+1,j+2), and a (i+2,j+2) are displayed in dark.

As illustrated in FIG. 3(a), at the same time when the photosensor at the region a(i+1,j+1) captures the image, the photosensors at regions a(i+4,j+1), and a(i+1,j+4), a(i+4,j+4) belonging to other groups in an area of FIG. 3 perform the image capturing operation. For this reason, regions a(i+3,j), a(i,j+3), and a(i+3,j+3) diagonally left above these regions a are also displayed in white.

Next, the photosensor at the region a(i+2,j+1) captures an image. In the meantime, the liquid-crystal panel 9 displays an image p2 as illustrated in FIG. 3(b). More specifically, the photosensor at the region a(i+2,j+1) diagonally left above the region a(i+2,j+1) is displayed in white. Seven regions, other than the region a(i+1,j) displayed in white, out of the eight regions a surrounding the region a(i+2,j+1) are all displayed in dark. More specifically, the regions a(i+2,j), a(i+3,j), a(i+1,j+1), a(i+3,j+1), a(i+1,j+2), a(i+2,j+2), and a(i+3,j+2) are all displayed in dark.

Next, the photosensor at the region a(i+3,j+1) captures an image. In the meantime, the liquid-crystal panel 9 displays an image p3 as illustrated in FIG. 3(c). More specifically, the photosensor at the region a(i+2,j) diagonally left above the region a(i+3,j+1) is displayed in white. Seven regions, other than the region a(i+2,j) displayed in white, out of the eight regions a surrounding the region a(i+3,j+1) are all displayed in dark. More specifically, the regions a(i+3,j), a(i+4,j), a(i+2,j+1), a(i+4,j+1), a(i+2,j+2), a(i+3,j+2), and a(i+4,j+2) are all displayed in dark.

Next, the photosensor at the region a(i+1,j+2) captures an image. In the meantime, the liquid-crystal panel 9 displays an image p4 as illustrated in FIG. 3(d). More specifically, the photosensor at the region a(i,j+1) diagonally left above the region a(i+1,j+2) is displayed in white. Seven regions, other than the region a(i,j+1) displayed in white, out of the eight regions a surrounding the region a(i+1,j+2) are all displayed in dark. More specifically, the regions a(i+1,j+1), a(i+2,j+1), a(i,j+2), a(i+2,j+2), a(i,j+3), a(i+1,j+3), and a(i+2,j+3) are all displayed in dark.

Similarly, the photosensors at regions a(i+2,j+2), a(i+3,j+2), a(i+1,j+3), a(i+2,j+3), a(i+3,j+3) capture images.

When the photosensor at the region a(i+2,j+2) performs the image capturing operation, the display pixel at the region a(i+1,j+1) is displayed in white. When the photosensor at the region a(i+3,j+2) performs the image capturing operation, the display pixel at the region a(i+2,j+1) is displayed in white. When the photosensor at the region a(i+1,j+3) performs the image capturing operation, the display pixel at the region a(i,j+2) is displayed in white. When the photosensor at the region a(i+2,j+3) performs the image capturing operation, the display pixel at the region a(i+1,j+2) is displayed in white. When the photosensor at the region a(i+3,j+3) performs the image capturing operation, the display pixel at the region a(i+2,j+2) is displayed in white.

FIG. 4 is a timing diagram illustrating timings of a display of a display pixel and the image capturing operation of the photosensor. As illustrated in FIG. 4, when the image p1 is written, the first photosensor in each group performs the image capturing operation. When the image p2 is written next, the second photosensors at each group performs the image capturing operation while data is read from the first photosensor at each group. Similarly, when the next image p3 is written, the third photosensor in each group performs the image capturing operation and data is read from the second photosensor.

The image capturing operation of the photosensor is performed during a period throughout which no image displaying is performed (such as a blanking period). To capture an image having a high contrast ratio, an exposure time of the photosensor is preferably set to be longer (to the order of several hundred milliseconds). The exposure time within the blanking period is preferably lengthened by lengthening the blanking period with a frequency of original image displaying retrained. If it is difficult to perform nine image capturing operations within a single blanking period, the nine image capturing operations may be performed across a plurality of blanking periods.

When the photosensor at the region a(k,m) performs the image capturing operation in the present embodiment as described above, only the pixel a(k−1,m−1) out of the eight regions a surrounding the region a(k,m) is displayed in white, and the pixels at the remaining seven regions a are displayed in dark. More specifically, in the arrangement of the present embodiment, a light ray reflected from the original document right above the photosensor is prevented from entering that photosensor. The photosensor thus detects only a light ray from diagonally above, thereby increasing the resolution of the captured image.

This advantage of the present embodiment is described below with reference to FIG. 5. As illustrated in FIG. 5(a), a photosensor s1 is present a region a(k,m) and performs the image capturing operation. Since the pixel at the region a(k,m) of the photosensor s1 performing the image capturing operation in the arrangement of the present embodiment is displayed in dark, a light ray incident on the region a(k,m) out of the light rays emitted from the back-light unit 7 is not transmitted through the liquid-crystal panel 9. No light ray that is reflected from the original document 10 right above the photosensor s1 and enters the photosensor s1 is present.

On the other hand, the pixel at the region a(k−1,m−1) is displayed in white, and a light ray Lb emitted from the back-light unit 7 and entering the region a(k−1,m−1) is transmitted through the region a(k−1,m−1) and then reflected from the original document 10. Part of light reflected from the original document 10 enters the photosensor s1 at a diagonal angle as denoted by reference symbol L1 in FIG. 5(a).

With the conventional arrangement where all the pixels are displayed in white while the image capturing operation is performed, both a light ray L2 reflected from the original document 10 right above the photosensor s1 and a light ray L1 reflected in a diagonal direction, out of reflected light rays of the output light rays Lb from the back-light unit 7, are incident on the photosensor s1 performing the image capturing operation as illustrated in FIG. 5(b). This is because an optical distance of the order of several hundred μm is present between the photosensor and the original document. If the reflected light ray L2 from right above and the reflected light ray L1 from diagonally above are incident on the photosensor, the reflected light ray L1 from diagonally above becomes a blurring component (noise). A blurred image thus results.

In the arrangement of the present embodiment, the reflected light ray from right above is intentionally uncaptured, and the photosensor detects only the light ray incident from diagonally above. An effective image capturing area (the area P1 in FIG. 5(a)) is reduced, and a high precision sensor image results. In FIG. 5(b), the effective image capturing area is an area P2. In comparison of the size of the region P1 with the size of the region P2, it is found that the arrangement of the present embodiment reduces the effective image capturing area.

The pattern of the display image captured in the image capturing operation of one photosensor is not limited to the example of FIG. 3. The pattern of the display image during the image capturing operation may be any pattern as long as a distance that permits a light ray diagonally to be incident on the photosensor performing the image capturing operation from a region displayed in white is appropriately ensured. For example, if the image capturing operation of the nine photosensors in the order described with reference to FIG. 3, an image pattern of FIG. 6 may be a preferred example.

The number of photosensors belonging to one group is not limited to nine, but may be optional. An execution order of the image capturing operation of the photosensors in one group is not be limited to the above-described order, but may be optionally determined.

### Second Embodiment

A photosensor builtin liquid-crystal display apparatus of a second embodiment of the present invention is described below with reference to the drawings. The same elements as those of the first embodiment are designated with the same reference symbols, and the detailed discussion thereof is omitted.

The photosensor builtin liquid-crystal display apparatus 1 of the second embodiment of the present invention is different from the first embodiment in that the image capturing operation is performed by the photosensors with the entire image displayed in dark, and that an offset removal is then performed in accordance with resulting data.

In accordance with the present embodiment, an image p10 all displayed in dark as illustrated in FIG. 7 and FIG. 8 is used in addition to the display image patterns of FIG. 3 and FIG. 6 described with reference to the first embodiment. Data acquired by the photosensors through the image p10 is subtracted from data acquired by the photosensors through the images P1 through p9. In this way, an offset of stray light is removed. Even if the display pixels are set to be in a dark display state, output light of the back-light unit 7 is not fully blocked, and there is a possibility that a slight degree of stray light is present.

In the example of FIG. 7 and FIG. 8, data of the photosensors with the image p10 displayed in dark is acquired after the photosensors perform the image capturing operation using each of the images p1 through p9, and the data of the photosensors with the image p10 is subtracted from the data acquired in the image capturing operation. A sensor image at a high accuracy level with the noise caused by a stray light component (offset) removed is thus obtained.

In FIG. 7 and FIG. 8, the data for noise removal with the image p10 all displayed in dark is obtained after the nine photosensors belonging to one group have performed the image capturing operation. The data acquisition timing using the image p10 is not limited to this timing, and may be optional.

The embodiments of the present invention have been described for exemplary purposes only, and a variety of modifications falling within the scope of the present invention is possible.

### INDUSTRIAL APPLICABILITY

The present invention finds industrial applications as a photosensor builtin liquid-crystal display apparatus that captures images from the outside.

1. A photosensor builtin display apparatus comprising:
an active matrix substrate having a plurality of pixel electrodes,
a counter substrate having a counter electrode opposed to the plurality pixel electrodes,
a display medium layer interposed between the active matrix substrate and the counter substrate, and
a photosensor arranged within a pixel region of the active matrix substrate,
wherein when the photosensor performs an image capturing operation, the display medium layer right above the photosensor is configured to be in a light-blocking state, and the display medium layer diagonally above the photosensor is configured to be in a light-transmissive state.

2. The photosensor builtin display apparatus according to claim 1, further comprising an image corrector unit that subtracts data acquired via the photosensor with an entire portion of the display medium layer in the light-blocking state from data acquired by the photosensor in the image capturing operation.

3. The photosensor builtin display apparatus according to claim 1, wherein the photosensor is a light detecting element that receives visible light.

4. The photosensor builtin display apparatus according to claim 3, further comprising a back-light unit,
wherein a light ray emitted from a light source of the back-light unit includes a visible light component.

5. The photosensor builtin display apparatus according to claim 3, further comprising a color filter arranged above the photosensor.

6. The photosensor builtin display apparatus according to claim 1, wherein the image capturing operation is performed within a blanking period.

7. The photosensor builtin display apparatus according to claim 1, wherein the display medium layer is a liquid-crystal layer.
